(19) United States
(12) Patent Application Publication
(10) Pub. No.: US 2018/0039086 A1
(43) Pub. Date: Feb. 8, 2018

(54) HEAD-MOUNTED ELECTRONIC DEVICE

(71) Applicant: Shenzhen Royole Technologies Co., Ltd., Shenzhen, Guangdong (CN)

(72) Inventors: Chao Jiang, Shenzhen, Guangdong (CN); Zihong Liu, Shenzhen, Guangdong (CN)

(21) Appl. No.: 15/553,432

(22) PCT Filed: Apr. 3, 2015
(86) PCT No.: PCT/CN2015/075918

§ 371 Date: Aug. 24, 2017

(51) Int. Cl. G02B 27/01; H04R 1/10

(52) U.S. Cl. CPC G02B 27/0176; G02B 27/0101; H04R 1/1008; G02B 27/0172; G02B 2027/014

(57) ABSTRACT

The present disclosure relates to a head-mounted electronic device. The head-mounted electronic device includes: a U-shaped head-mounted headphone; a U-shaped display component rotatably connected to the headphone; a sensor component disposed to the headphone and configured to sense a wearing state of the headphone; and a control means electrically connected to the sensor component and configured to control the display component and/or the headphone to make a correlative response when the sensor component senses that the headphone is switched between the wearing state and a non-wearing state.

### CROSS REFERENCE TO RELATED APPLICATION

The present application is a Section 371 U.S. National Stage Application of International Application No. PCT/CN2015/075918, filed on Apr. 3, 2015, the content of which is incorporated herein by reference in its entirety, and published as WO 2016/155019 A1, on Oct. 6, 2016, not in English.

### FIELD

The present disclosure relates to a technology of automatic control, and particularly to a head-mounted electronic device having a function of automatic control.

### BACKGROUND

At present, a wearable electronic device becomes more and more popular because of its great visual experience effect. The wearable electronic device usually includes a video part and an audio part. In order to achieve a great audio effect, some wearable electronic devices adopt a head-mounted headphone. In this case, the video part is rotatably connected to the head-mounted headphone. When the wearable electronic device is not in use, the video part is rotated to a position where the video part is substantially coincided with the head-mounted headphone for a convenient storage. When the wearable electronic device is needed to be used, the video part is rotated to a position defining an included angle of substantially 90 degrees between the video part and the head-mounted headphone. Accordingly, when the wearable electronic device is put on, the video part is located in front of eyes.

When the user wears the wearable video device to view video and needs to take off the wearable video device midway, the user usually needs to pause the video play manually at first and then to take off the wearable video device, so as to prevent a playback of some video content in subsequent. However, this process is pretty cumbersome.

### SUMMARY

Embodiments of the present disclosure provide a head-mounted electronic device with automatic control.

The head-mounted electronic device includes: a U-shaped head-mounted headphone; a U-shaped display component rotatably connected to the headphone; a sensor component disposed to the headphone and configured to sense a using state of the headphone; and a control means electrically connected to the sensor component and configured to control the display component and/or the headphone to make a response when the sensor component senses that the headphone is switched between a wearing state and a non-wearing state.

With the technical solution in the present disclosure, the video play may be stopped without any other operations in the process that the user takes off the head-mounted electronic device, so it is very convenient for the user to use and a user experience is improved greatly.

### BRIEF DESCRIPTION OF THE DRAWINGS

The following accompanying drawings are used for illustrating various embodiments of the present disclosure in detail in combination with specific embodiments. It should be understood that various elements illustrated in the accompanying drawings do not represent actual sizes and scale relations, and the accompanying drawings are only schematic views intended for clear illustration. Thus, the accompanying drawings should not be construed to limit the present disclosure.

FIG. 1 is a schematic view of a head-mounted electronic device provided in a first embodiment of the present disclosure.

FIG. 2 is a block diagram of the head-mounted electronic device in FIG. 1.

FIG. 3 is a partially exploded view of the head-mounted electronic device in FIG. 1.

FIG. 4 is a schematic view of a head-mounted electronic device provided in a second embodiment of the present disclosure.

FIG. 5 is a partial section view of the head-mounted electronic device in FIG. 4.

FIG. 6 is a schematic view of a head-mounted electronic device provided in a third embodiment of the present disclosure.

FIG. 7 is a schematic view of a head-mounted electronic device provided in a fourth embodiment of the present disclosure.

FIG. 8 is section view of an elastic headband of the head-mounted electronic device in FIG. 7.

FIG. 9 is a section view of an elastic headband of a head-mounted electronic device provided in a fifth embodiment of the present disclosure.

### DETAILED DESCRIPTION

In order to make the objectives, technical solutions and advantages of the present disclosure more definite and clear, the present disclosure is further illustrated in detail in combination with a plurality of embodiments and accompanying drawings. It should be understood that, the specific embodiments described herein are only used for explaining the present disclosure and not for limiting the present disclosure. In addition, the presentation doesn't represent actual scale relations among various elements, but is only intended for schematic illustration.

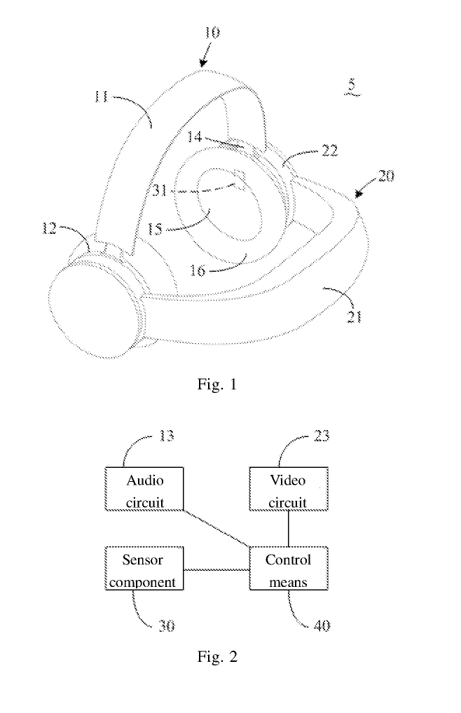

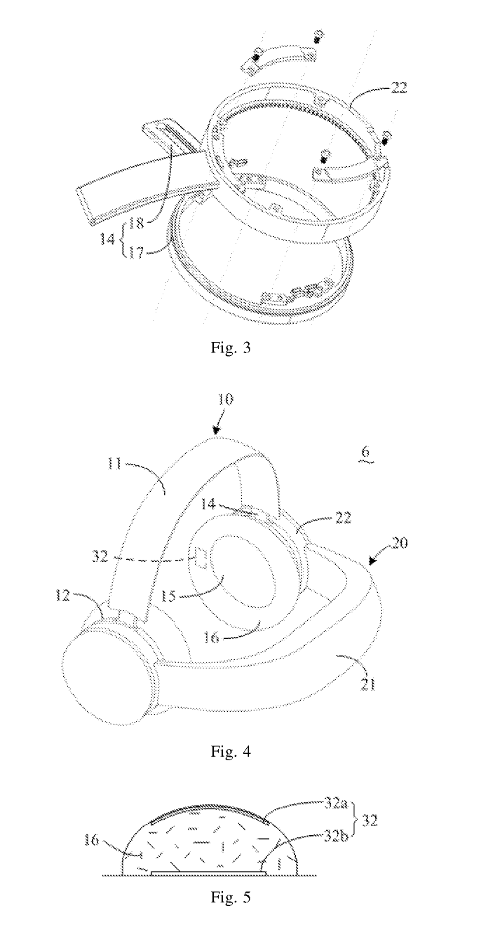

In combination with FIG. 1 to FIG. 3, which are a schematic view, a block diagram and a partially exploded view of a head-mounted electronic device 5 provided in a first embodiment of the present disclosure, the head-mounted electronic device 5 is a head-mounted displayer in the embodiment, and includes a head-mounted headphone 10, a display component 20, a sensor component 31 and a control means 40.

The head-mounted headphone 10 includes an elastic headband 11, two sound generators 12 and an audio circuit 13. The elastic headband 11 is U-shaped and configured to be deformed to provide a stress which presses the sound generator against ears of the user when the user wears the headphone 10. Each of the two sound generators 12 includes a moving piece 14, a loudspeaker (not illustrated in the drawings), a sounding surface 15 and an earmuff 16. The moving piece 14 includes an annular wall 17 and an engaging portion 18 extending outwards from the annular wall 17. The loudspeaker is disposed in a space surrounded by the annular wall 17, and the sounding surface 15 is located at a side of the loudspeaker in which sound is emitted, that is the sound is emitted from the sounding surface 15. The earmuff 16 is fixed to the sounding surface 15. The engaging portion 18 is moveably connected to the elastic headband 11, so that the sound generator 12 may move with respect to the elastic headband 11, and thus it is convenient to adjust the sound generator 12 to positions suitable for different users to wear the head-mounted electronic device 5.

The display component 20 includes a U-shaped display member 21 configured for displaying an image to be viewed by the user, two connecting pieces 22 located at two opposite end parts of the display member 21 and a video circuit 23. The video circuit 23 is accommodated in the display member 21, an optical unit (not illustrated in the drawings) in cooperation with the video circuit 23 is accommodated in middle of the display member 21, and the video circuit 23 has a micro display unit and a matched control circuit. An image displayed by the micro display unit is projected to user's eyes in an optical path defined by the optical unit, so that the user can view an enlarged virtual image. A working principle of the display component 20 is familiar to those skilled in the related art, and thus will not be repeated in the present specification. The connecting piece 22 has an annular shape, and the annular wall 17 of the headphone 10 can just be partially accommodated in the connecting piece 22, so that the annular wall 17 may rotate in the connecting piece 22.

The sensor component 31 is disposed to the headphone 10 and configured for sensing a using state of the headphone. In the embodiment, the sensor component 31 includes a pressure sensor disposed to the headphone 10. In the embodiment, the pressure sensor is disposed to the sounding surface 15 of the sound generator 12, specifically an area of the sounding surface 15 covered by the earmuff 16 or a part of the earmuff 16, so as to sense a pressure applied to the headphone 10 when the user puts on the headphone 10. A predetermined range of pressure, for example being larger than a certain pressure value, may be defined in advance. When the pressure value sensed by the pressure sensor is in the predetermined range, the headphone is judged to be in a wearing state, otherwise to be in a non-wearing state. Certainly, the pressure sensor is not limited to one as in the embodiment, and a plurality of pressure sensors may be provided, or each of the sound generators may be provided with the pressure sensor. In addition, the pressure sensor may also be disposed to a portion of the elastic headband 11 apt to contact the user's head, for example a middle portion of an inward surface of the elastic headband 11, which can also implement a same function.

The control means 40 is electrically connected to the sensor component 31 and configured to control the display component 20 to respond when the sensor component 31 senses that the headphone 10 is switched between the wearing state and the non-wearing state. Certainly, the control means 40 may further control the headphone 10 to respond. Specifically, the control means 40 is further electrically connected to the audio circuit 13 and the video circuit 23, and is disposed in the display component 20 or the headphone 10, which may be determined according to an accommodating space defined by a specific structure. In the embodiment, when the pressure value sensed by the pressure sensor is larger than a pressure value A, i.e. in the above predetermined range, the headphone is in the wearing state; when the pressure value sensed by the pressure sensor is smaller than the pressure value A or a pressure value B (B is smaller than A), i.e. in a range corresponding to the non-wearing state, the headphone is in the non-wearing state. The control means 40 controls the display component 20 in a video-play-paused state to play video, when the pressure value detected by the pressure sensor changing from the range corresponding to the non-wearing state into the predetermined range of the wearing state. Certainly, the control means 40 can further control the headphone 10 to play the sound.

In the use process, after putting on the headphone 10, the user can rotate the display component 20 to a position where the display component 20 has an included angle of substantial 90 degrees with the headphone 10. At this moment, the display component 20 is located in front close to the user's eyes, so that the user may view the images. After the headphone 10 is put on, because of an elastic force of the elastic headband 11, the pressure value sensed by the pressure sensor is larger than a predetermined value, i.e. in the predetermined range, and thus the headphone 10 is judged to be in the wearing state by the control means 40. In the process of using some functions of the head-mounted electronic device 5, for example playing the video, if the user has other matters to deal with and needs to take off the electronic device 5 and pause playing the video, the user may only need to take off the head-mounted electronic device 5. At this moment, as the pressure value sensed by the pressure sensor is almost zero, i.e. outside of the predetermined range, the control means 40 judges that the headphone is in the non-wearing state and controls the video circuit 23 and the audio circuit 13 to stop working, thus pausing the play of video and audio. As the video play can be stopped without any other operations during the user taking off the head-mounted electronic device 5, it is very convenient for the user to use and the user experience is greatly improved. It should be pointed out that, pausing of the video play of the display component 20 may indicate that the image is shown, but in a still state, or no image is shown, i.e. a blank screen, or the blank screen occurs automatically after the still image is shown for a period of time. All of the methods above can realize the purpose of pausing the video play.

Preferably, the headphone is judged to be in the wearing state when the pressure value sensed by the pressure sensor is in the predetermined range and the pressure value stays in the predetermined range over a first preset time, so that it is possible to identify that the headphone is in the wearing state more accurately.

In other embodiments, the control means 40 may also control the display component 20 to respond when the sensor component 31 senses that a relative position between the headphone 10 and the display component 20 is in a predetermined range, i.e., the display component 20 in the video-play-paused state plays video when the headphone 10 is switched from the non-wearing state to the wearing state. Preferably, for the display component 20 in the video-play-paused state, when the headphone 10 is switched from the non-wearing state to the wearing state and the wearing state lasts over a second preset time, the control means 40 controls the display component 20 to play video and/or the headphone 10 to output audio. Such design reserves a certain adjustment time for the user before playing video and/or audio, after the user puts on the head-mounted electronic device 5, which is beneficial for the user to view the video in a better state. Certainly, the function described in this paragraph and the preceding functions can be superposed in one same head-mounted electronic device 5.

In combination with FIG. 4 and FIG. 5, which are a schematic view and a partial section view of a head-mounted electronic device 6 provided in a second embodiment of the present disclosure, the second embodiment mainly differs from the first embodiment in a sensor component 32. The sensor component 32 includes a first metal piece 32a and a second metal piece 32b, and at least a part of the earmuff 16 is located between the first metal piece 32a and the second metal piece 32b. In the embodiment, the first metal piece 32a may be attached to an outside coating of the earmuff 16, for example an inner side of leather, and the second metal piece 32b may be attached to the sounding surface. In this case, a part of filler (for example foam materials) of the earmuff 16 is erected between the first metal piece 32a and the second metal piece 32b, and hence the sensor component 32 is configured as a capacitor. When the user puts on the headphone 10, a distance between the first metal piece 32a and the second metal piece 32b changes, so a capacitance of the sensor component 32 changes. Accordingly, a change state of the capacitance reflects that whether the user wears the headphone 10 or not. Other working principles are similar to those of the first embodiment, and will not be repeated herein.

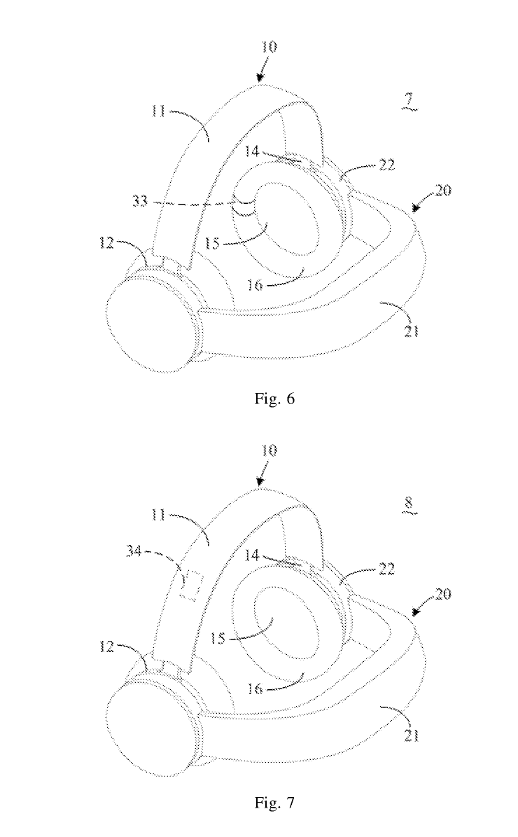

In combination with FIG. 6, which is a schematic view of a head-mounted electronic device 7 provided in a third embodiment of the present disclosure, the third embodiment mainly differs from the first embodiment in a sensor component 33. The sensor component 33 includes a capacitive touch screen disposed to the earmuff 16. For example, the capacitive touch screen is disposed to an outer surface of the earmuff 16 directly facing the user, i.e., the capacitive touch screen contacts the skin of the user directly for sensing. Or, the capacitive touch screen is disposed to an inner side of the outside coating of the earmuff 16, i.e., the capacitive touch screen contacts the skin of the user indirectly for sensing. It may be understood that a position of the capacitive touch screen is not limited, as long as the capacitive touch screen may sense the contact with the user. Certainly, the capacitive touch screen may also be disposed to the sounding surface 15. In the third embodiment, it is possible to know whether the headphone is in the wearing state by using the capacitive touch screen to sense its contact with the skin of the user. In the present disclosure, the sensed contact with the skin of the user includes the above direct contact and the above indirect contact. Other principles are similar to those of the first embodiment, and will not be repeated herein.

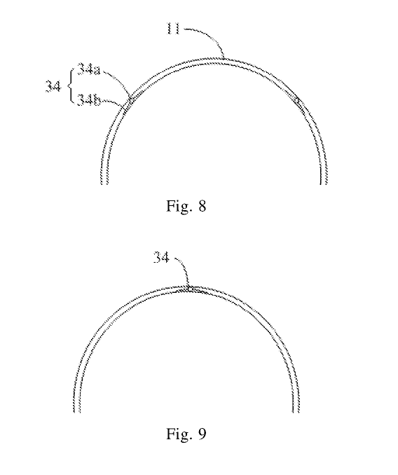

In combination with FIG. 7 and FIG. 8, which are a schematic view of a head-mounted electronic device provided in a fourth embodiment of the present disclosure and a section view of an elastic headband of the head-mounted electronic device, the fourth embodiment mainly differs from the first embodiment in a sensor component 34. The sensor component 34 is an angle sensor disposed to the elastic headband 11, and includes a fixed portion 34a fixed to the elastic headband and two movable portions 34b located at two sides of the fixed portion 34a. The movable portion 34b keeps abutting against the elastic headband 11. Accordingly, when the elastic headband is deformed at a position of the angle sensor, the angle sensor may sense such deformation. In the embodiment, two angle sensors are respectively provided at two sides of the middle of the elastic headband 11 where the deformation extent is relatively large, so as to sense the angel change accurately. It should be understood that, the number and the positions of the angle sensors are not limited to the above manner. For example, one angel sensor may be provided at the middle of the elastic headband 11. As illustrated in FIG. 9, in the fifth embodiment, the angle sensor senses whether the elastic headband 11 is expanded when the user puts on the headphone by sensing the deformation of the elastic headband 11, so as to determine whether the headphone is in the wearing state. The other working principles are similar to those of the first embodiment, and will not be repeated herein.

Certainly, in the various embodiments described above, specific solutions in different embodiments can be used in combination with one another. For example, the pressure sensor is used in conjunction with the touch screen, thus achieving a more accurate judgment. In addition, it should be noted that, the above head-mounted electronic device is not limited to playing the video, but may also be another head-mounted electronic device, such as a head-mounted game device, a head-mounted navigation device and the like. All of the head-mounted electronic devices having content of the present disclosure can realize the above convenient function of automatic control.

The above descriptions are only preferable embodiments of the present disclosure and are not intended to limit the present disclosure. Any modifications, equal alternatives, and improvements made within the spirit and principle of the present disclosure should be included in the protection scope of the present disclosure.

1. A head-mounted electronic device, comprising:
a U-shaped head-mounted headphone;
a U-shaped display component rotatably connected to the headphone;
a sensor component disposed to the headphone and configured to sense a wearing state of the headphone; and
a control means electrically connected to the sensor component and configured to control the display component and/or the headphone to make a correlative response when the sensor component senses that the headphone is switched between the wearing state and a non-wearing state.

2. The head-mounted electronic device according to claim 1, wherein the sensor component comprises at least one pressure sensor, and the headphone is judged to be in the wearing state when a pressure value sensed by the pressure sensor is in a predetermined range.

3. The head-mounted electronic device according to claim 2, wherein the headphone is judged to be in the wearing state when the pressure value sensed by the pressure sensor is in the predetermined range and stays in the predetermined range over a first preset time.

4. The head-mounted electronic device according to claim 2, wherein the headphone comprises a U-shaped elastic headband and two sound generators connected to the elastic headband, and the pressure sensor is disposed to the sound generator.

5. The head-mounted electronic device according to claim 4, wherein each of the two sound generators comprises a sounding surface and an earmuff, sound is emitted from the sounding surface, and the earmuff is disposed to the sounding surface,
the earmuff is configured to be pressed in the wearing state,
the sensor component is disposed to the sounding surface or the earmuff.

6. The head-mounted electronic device according to claim 1, wherein the headphone comprises two sound generators, each of the two sound generators has an earmuff, and the earmuff is configured to be pressed in the wearing state,
the sensor component comprises a first metal piece and a second metal piece, and at least a part of the earmuff is located between the first metal piece and the second metal piece,
the headphone is judged to be in the wearing state when the sensor component senses that a capacitance value between the first metal piece and the second metal piece is in a predetermined range.

7. The head-mounted electronic device according to claim 1, wherein the headphone comprises two sound generators, each of the two sound generators comprises a sounding surface and an earmuff, sound is emitted from the sounding surface, and the earmuff is disposed to the sounding surface,
the sensor component comprises at least one capacitive touch screen disposed to the sounding surface or the earmuff, and
the headphone is judged to be in the wearing state when the capacitive touch screen senses a skin touch.

8. The head-mounted electronic device according to claim 1, wherein the sensor component comprises at least one angle sensor disposed to the elastic headband, and the headphone is judged to be in the wearing state when an angle value sensed by the angle sensor is in a predetermined range.

9. The head-mounted electronic device according to claim 8, wherein the sensor component comprises one angle sensor disposed at a middle portion of the elastic headband and configured to sense a deformation degree of the elastic headband.

10. The head-mounted electronic device according to claim 8, wherein the sensor component comprises two angle sensors respectively disposed at two sides of a middle portion of the elastic headband and configured to sense a deformation degree of the elastic headband.

11. The head-mounted electronic device according to claim 1, wherein the response made by the display component comprises that the display component in a video-play state pauses the video play when the headphone is switched from the wearing state to the non-wearing state.

12. The head-mounted electronic device according to claim 1, wherein the response made by the display component comprises that the display component in a video-play-paused state plays video when the headphone is switched from the non-wearing state to the wearing state.

13. The head-mounted electronic device according to claim 12, wherein when the headphone is switched from the non-wearing state to the wearing state and the wearing state lasts over a second preset time, the display component plays video.
